(19) United States
(12) Patent Application Publication
(10) Pub. No.: US 2008/0077783 A1
(43) Pub. Date: Mar. 27, 2008

(54) Method of integrating image and release note of BIOS

(75) Inventors: Ying-Chih Lu, Taipei (TW); Ling-Hung Yu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/526,580

(22) Filed: Sep. 26, 2006

(51) Int. Cl. G06F 15/177

(52) U.S. Cl. 713/1

(57) ABSTRACT

In a method of integrating image and release note of BIOS, a memory space such as flash ROM used for storing machine codes of the BIOS is planned at least one independent block with a specific length, and each block is used for storing a release note of the BIOS. All release notes of the BIOS are compiled into at least one independent binary module, and the binary module is compressed according to actual requirements. In the process of building the BIOS, the compressed binary module is placed in the image of the BIOS, and the image of the BIOS is written into each block. When a setup utility of the BIOS is executed, all release notes of the BIOS can be displayed through an output device, so that a user can select and search a related item of each release note through an input device such as a keyboard.

### FIELD OF THE INVENTION

The present invention relates to a method of integrating an image and a release note of a basic input/output system (BIOS), and more particularly to a method that can display all BIOS release notes when a BIOS setup utility is executed.

### BACKGROUND OF THE INVENTION

In general, a computer manufacturer usually sends an image and a release note of a BIOS to each computer user, or publish the image and release note on the computer manufacturer's website for users to download whenever there is a new release of computer BIOS, so that users can know about the related information described in the BIOS release note and select whether or not to update the BIOS of their computer. Each BIOS release note generally includes the following information:

(1) an item change list that adds, deletes or changes an item between the present release and previous releases;

(2) cautions for each release including the cautions for updating /recovering BIOS, BMC versions for a new release of BIOS, known issues of the new release, and versions of motherboards applicable for the new release, etc;

(3) a computer manufacturer's website for users to download a newly released BIOS;

(4) a new version of BIOS; and

(5) a binary code release information existed in the contents of a new release of BIOS such as the release information of a PCI option ROM image/firmware, and a micro code of a CPU, etc.

Although the method of providing BIOS image and information of a new release of BIOS allows users to know about the related information of the BIOS release conveniently, so as to determine whether or not to update the BIOS for their computer, yet the ways of sending e-mails to users or publishing the BIOS image and release note on a computer manufacturer's website for users to download are existed in a separate and independent manner. Therefore, only those who receive or download the BIOS release notes can know about the contents. After a user updates a BIOS in their computer and anyone (including a BIOS developer, a tester, or a maintenance person) obtains the computer, the user cannot know the contents of the release note of the BIOS on their motherboard and the changes such as adding, deleting or modifying an item in previous releases. If the BIOS release note is obtained through other channels, a correct release note cannot be found easily or a wrong release note may be adopted due to the long time or the change of new releases for many times. As to BIOS developers, testers, computer maintenance people, or others, the foregoing situation will make debugging very difficult, since it is difficult to determine whether or not a computer failure is caused by the change of BIOS versions, and it is necessary to spend much time and efforts on detecting errors.

### SUMMARY OF THE INVENTION

In view of the foregoing shortcomings of the prior art that consume much efforts and time to know about the changes such as adding, deleting or modifying an item between the present release and previous releases for detecting errors of a computer, the inventor of the present invention based on years of experience to conduct extensive researches and experiments, and finally invented a method of integrating image and release note of BIOS in accordance with the present invention, in hope of displaying all BIOS release notes through an output device (such as an LCD panel), when a BIOS setup utility is executed, so that users can search a related item of each release note by an input device (such as a keyboard), so as to know about the present release note and the added, deleted or modified items between the present release and previous releases immediately.

It is a primary objective of the present invention to provide a method comprising the steps of: planning at least one independent block with a predetermined length in a memory space such as a flash ROM for storing the machine codes of a computer BIOS, and each block is provided for storing a BIOS release note; compiling all BIOS release notes into at least one independent binary module, and the binary module is compressed according to actual needs, and during the process of building a BIOS, the compressed binary module is stored in the BIOS image, and then the BIOS image is written in each block; and displaying all BIOS release notes through an output device (such as an LCD panel) when the BIOS setup utility is executed, such that users can select to search a related item in each release note through an input device (such as a keyboard). Therefore, a BIOS developer, a tester, a computer maintenance person or anyone can know about the present release note and the added, deleted and modified items immediately when the BIOS setup utility is executed, and further can quickly determine the cause of a bug in the computer according to the testing of the added, deleted and modified items of each release, and immediately modify the BIOS for a retest to confirm the item causing the bug, and debug according to the change of BIOS release, so as to effectively save or exempt the time and efforts for the testing and debugging processes.

Another objective of the present invention is to let a user select a BIOS release note submenu on a setup menu, if the BIOS executes a power on self-test and the user selects to enter the BIOS setup utility by operating a keyboard. The computer reads the binary module stored in a block and decompresses the binary module, and then searches the corresponding BIOS release note based on a signature of the BIOS release note, and finally displays the BIOS release note through an LCD panel of the computer.

A further objective of the present invention is to store a signature of a BIOS release note beginning in the first byte of each block, a checksum in the last byte, and all BIOS release notes in the remaining bytes.

Another objective of the present invention is to include three types of data structures for the remaining bytes for storing all BIOS release notes, wherein a first data structure is provided for storing a data structure of each version, and a second data structure is provided for storing a corresponding subject of each version, and a third data structure is provided for storing a corresponding item of each subject.

Another objective of the present invention is to provide a first data structure that includes three fields, wherein a first field is provided for storing a string of a version, and a second field is provided for storing a pointer connected to a data structure of a next version, and a third field is provided for storing a pointer connected to a data structure of a first subject of the corresponding version; a second data structure that includes three fields, wherein a first field is provided for storing a string of a subject, and a second field is provided for storing a pointer connected to a data structure of a next subject, and a third field is provided for storing a pointer connected to a data structure of a first item corresponding to the subject; and a third data structure that includes two fields, wherein a first field is provided for storing a string of an item, and a second field is provided for storing a pointer connected to a data structure of a next item.

To make it easier for our examiner to understand the objective of the invention, its structure, innovative features, and performance, we use a preferred embodiment together with the attached drawings for the detailed description of the invention.

The above and other objects, features and advantages of the present invention will become apparent from the following detailed description taken with the accompanying drawings.

### BRIEF DESCRIPTION OF THE DRAWINGS

FIG. 1 is a flow chart of a method of the present invention;

FIG. 2 is a schematic view of a structure of planning at least one independent block with a predetermined length in advance for a flash ROM for storing computer machine codes of a BIOS according to the present invention; and

FIG. 3 is a schematic view of the bytes for a data structure of each block for storing all BIOS release notes according to the present invention.

### DETAILED DESCRIPTION OF THE PREFERRED EMBODIMENTS

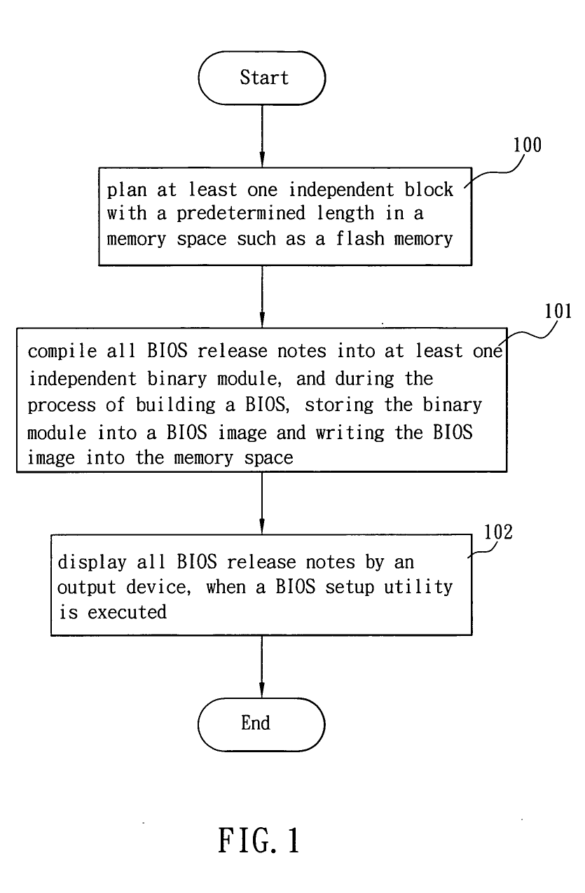

Referring to FIG. 1 for a method of integrating an image and a release note of a basic input/output system (BIOS), the method is applied to a computer (such as a desktop computer, a notebook computer and a server, etc) and comprises the steps of:

(100) planning at least one independent block with a predetermined length in a memory space such as a flash ROM of a computer for storing machines codes of a BIOS, and each block is provided for storing a BIOS release note;

(101) compiling all BIOS release notes into at least one independent binary module, and the binary module is compressed according to actual needs, and during the process of building the BIOS, the compressed binary module is stored in the BIOS image, and then the BIOS image is written into each block; and

(102) displaying all BIOS release notes through an output device (such as an LCD panel) when a BIOS setup utility is executed, such that a user can select to search a related item in each release note through an input device (such as a keyboard).

Therefore, a BIOS developer, a tester, a computer maintenance person or anyone can know about the present release note and the added, deleted and modified items immediately when the BIOS setup utility is executed, and further can quickly determine the cause of a bug of the computer according to the testing of the added, deleted and modified items of each release, and can immediately modify the BIOS for a retest to confirm the item causing the bug, and debug according to the change of BIOS release, so as to effectively save or exempt the time and efforts for the testing and debugging processes.

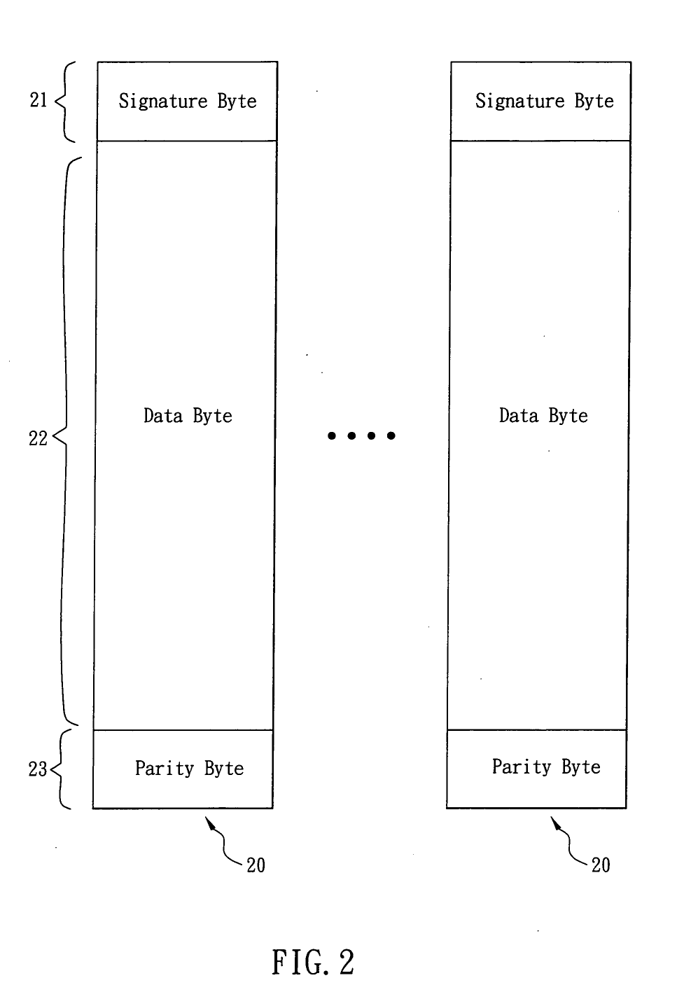

Referring to FIG. 2 for a preferred embodiment of the present invention, the method plans at least one independent block 20 with a predetermined length in a flash ROM for storing the machine codes of a BIOS in a computer. In this embodiment, the length of each block is 64K bytes, but the length of the block 20 is not limited to such arrangement and can be planned according to actual needs in other embodiments. Each block is provided for storing a BIOS release note, wherein the last 18 bytes 21 are used for storing a signature of the BIOS release note, and the last byte 23 is used for storing a checksum, and the remaining bytes 22 are used for storing the data of all BIOS release notes. Before the BIOS is built again, the present release and all previous release notes are added into the BIOS and rebuilt it, and then the newly built BIOS is written into a flash ROM, such that the present release note and all previous release notes of the BIOS are sequentially stored in the foregoing blocks 20. When the BIOS executes a power on self-test (POST) and a user selects to enter the BIOS setup utility through a keyboard, the user can select the BIOS release note submenu from a setup menu displayed on an LCD panel of a computer. By then, the computer reads the binary module stored in the blocks 20 of the flash ROM, and the binary module is decompressed, and the corresponding BIOS release note is searched according to a signature of the BIOS release note and displayed through an LCD panel of a computer.

In this embodiment, if the computer is booted and a power on self-test (POST) of a BIOS is executed and a user selects to enter a BIOS setup utility by operating a keyboard, the user can select a BIOS release note submenu on setup menu displayed on an LCD panel. The computer displays the basic data of all BIOS releases on the LCD panel as shown in the following table. The basic data include all BIOS versions and related descriptions for user's review or selection through the keyboard:

| Version | Description |
|---|---|
| V1.04 | S5000.86B.01.00.0017.120920051151 |
| V1.05 | S5000.86B.01.00.0018.120920051151 |
| V1.06 | S5000.86B.01.00.0019.120920051151 |
| V1.07 | S5000.86B.01.00.0020.120920051151 |

If a user selects a field of version V1.07 through a keyboard and the LCD panel will display the data of a next level of the version V1.07 as shown in the table. The table includes a subject and a description for the browsing and selection made by users:

| | Description |
|---|---|
| Version | |
| V1.07 | S5000.86B.01.00.0020.120920051151 |
| Subject | |
| 1 | Known Issues |
| 2 | BIOS Location |
| 3 | Embedded Option ROM Image/Firmware Version |
| 4 | CPU Micro Code Included in BIOS |
| 5 | Major Change of this Version of BIOS |
| 6 | Procedure for Upgrading System BIOS Version |
| 7 | Create the BIOS Crisis Recovery |

If a user selects the field of known issues through the keyboard, the LCD panel will display the data of a next level of known issues as shown in the table. The table includes a version and a description for the browsing made by user:

| Version | Description |
|---|---|
| V1.07 | S5000.86B.01.00.0020.120920051151 |

Subject: Known Issues

| Subject | Description |
|---|---|
| 1 | The Windows 2000 with ACPI mode cannot be installed. |
| 2 | The MPS mode is not supported yet. |
| 3 | This version of BIOS is applicable for A02 motherboard |
| | only. |
| 4 | It supports BMC version 1.5 or above |

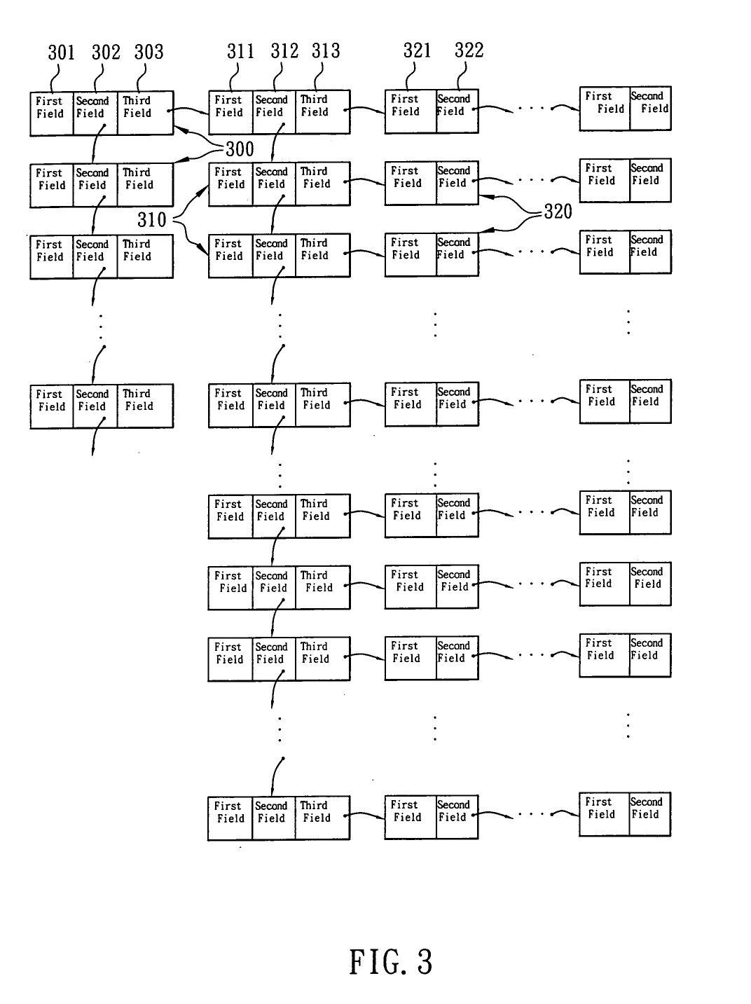

In this embodiment as shown in FIG. 2, the flash ROM includes three types of data structure as shown in FIG. 3 for storing the bytes 22 of all BIOS release notes in each block 20, and a first data structure 300 is provided for storing a related data of each version, and a second data structure 310 is provided for storing a related data of a subject corresponding to each version, and a third data structure 320 is provided for storing a related data of an item corresponding to each subject, wherein the first data structure 300 includes three fields, and a first field 301 is provided for storing a string of a version (such as Ver_1, Ver_2, and Ver_3 etc), and a second field 302 is provided for storing a pointer connected to a data structure of a next version, and a third field 303 is provided for storing a pointer connected to a data structure of a first subject corresponding to the version number; the second data structure 310 also includes three fields, and a first field 311 is provided for storing a string of a subject (such as Sub_1, Sub _2, and Sub _3, etc ) and a second field 312 is provided for storing a pointer connected to a data structure of a next subject, and a third field 313 is provided for storing a pointer connected to a data structure of a next item corresponding to the subject; the third data structure 320 only includes two fields, and a first field 321 is provided for storing a string of an item (such as Item_1, Item _2, and Item_3 ), etc, and a second field 322 is provided for storing a pointer connected to a data structure of a next item, and the versions, subjects and items of all the BIOS release notes can be stored into each block 20 of the flash ROM sequentially in a simple, quick and clear manner by the tree-structured of the foregoing data structure. Therefore, a BIOS developer, a tester, a computer maintenance person or anyone can know about the present release note and the added, deleted and modified items immediately when the BIOS setup utility is executed, so as to quickly determine the cause of a bug of the computer, and immediately debug the BIOS for the change of BIOS release, so as to significantly simplify the debugging process and effectively save the time and efforts for the testing and debugging processes.

While the invention herein disclosed has been described by means of specific embodiments, numerous modifications and variations could be made thereto by those skilled in the art without departing from the scope and spirit of the invention set forth in the claims.

What is claimed is:

1. A method of integrating an image and a release note of a BIOS, being applied to a computer and comprising the steps of:
planning at least one independent block with a predetermined length in a memory space for storing a plurality of BIOS machine codes, and each block being provided for storing a BIOS release note;
compiling all BIOS release notes into at least one independent binary module, and during the process of building said BIOS, storing said binary module into a BIOS image first and then writing a BIOS image into each block; and
displaying said all BIOS release notes by an output device, when a BIOS setup utility is executed.

2. The method of claim 1, wherein said binary module is compressed and stored into said BIOS image first, and then said BIOS image is written into said each block.

3. The method of claims 1, wherein a LCD panel of said computer will display a BIOS setup menu if said BIOS executes a power on self-test and a user selects to enter said BIOS setup utility by operating a keyboard, and said BIOS setup menu includes an option for said BIOS release note.

4. The method of claims 2, wherein a LCD panel of said computer will display a BIOS setup menu if said BIOS executes a power on self-test and a user selects to enter said BIOS setup utility by operating a keyboard, and said BIOS setup menu includes an option for said BIOS release note.

5. The method of claim 3, wherein said each block includes a first data structure is provided for storing a related data of each version, and a second data structure is provided for storing a related data of a subject corresponding to said each version, and a third data structure is provided for storing a related data of an item corresponding to said each subject.

6. The method of claim 4, wherein said first data structure includes a first field is provided for storing a string of a version, and a second field is provided for storing a pointer connected to a data structure of a next version, and a third field is provided for storing a pointer connected to a data structure of a first subject corresponding to said version.

7. The method of claim 5, wherein said second data structure includes a first field is provided for storing a string of a subject, and a second field is provided for storing a pointer connected to a data structure of a next subject, and a third field is provided for storing a pointer connected to a data structure of a first item corresponding to said subject.

8. The method of claim 6, wherein said third data structure includes a first field is provided for storing a string of an item, and a second field is provided for storing a pointer connected to a data structure of a next item data.
